(19) United States
(12) Patent Application Publication
(10) Pub. No.: US 2019/0351837 A1
(43) Pub. Date: Nov. 21, 2019

(54) HITCH-MOUNTED CARRIER DEVICE

(71) Applicant: Alan Murray, Brookings, OR (US)

(72) Inventor: Alan Murray, Brookings, OR (US)

(21) Appl. No.: 15/984,921

(22) Filed: May 21, 2018

(51) Int. Cl. B60R 9/10; B60D 1/155; B60R 9/06; B60D 1/46; B60D 1/52; B60D 1/54

(52) U.S. Cl. CPC B60R 9/10; B60D 1/155; B60D 1/54; B60D 1/46; B60D 1/52; B60R 9/06

(57) ABSTRACT

A receiver to be received in a tubular hitch with leaf springs mounted cantileverly to the inside thereof to bias locking buttons out through locking bores to releasably lock to the hitch.

### CROSS-REFERENCES TO RELATED APPLICATIONS

This application is related to U.S. application Ser. No. ______, entitled “Coupler” filed May 21, 2018 and U.S. application Ser. No. ______, entitled “Collapsible Carrier Rack” filed May 21, 2018, the entireties of which are hereby incorporated herein by reference.

### BACKGROUND

### Field of the Invention

The present invention relates to carrier devices for attachment to a trailer hitch for carrying items for transport with a vehicle.

### Description of the Prior Art

Hitch-mounted carrier devices have long been known in the art and have particular utility for carrying bicycles from the rear of a vehicle. By some reports, there are upwards of fifty to sixty million bicycles in the USA and the owners of many desire to transport their bicycles from the exterior of an automobile. This has led to various different proposals for bicycle racks or carriers to be carried from the trailer hitch of a vehicle. Such carriers are known to support horizontal trays, baskets or racks behind the vehicle bumper and vertical stems supported on square tube hitch receivers. By way of further example, it has been proposed to construct a carrier device with multiple arms articulated together and constructed to be telescoped into one another for compact storage. A device of this type is shown in U.S. Pat. No. 9,713,989 to Anton. Such devices, while effective for carrying loads from a bicycle hitch, are cumbersome and complicated to manufacture and are inconvenient to fold away for storage.

Various designs have been proposed for hitch receivers including a square tube to be telescoped into the open end of a tubular trailer hitch for carrying a ball constructed to receive a spherical cavity in a trailer tongue. A device of this type is shown in U.S. Pat. No. 6,902,181 to Dye.

### SUMMARY OF THE INVENTION

The present invention includes a channel shaped receiver for telescopical receipt in the open end of a tubular trailer hitch and mounting at the distal extremity thereof a stem pivotable from an erect position to a folded position, received in the channel of the receiver for compact storage. A carrier, such as a crossbar with hooks for carrying bikes is mounted to the top or distal end of the stem.

### BRIEF DESCRIPTION OF THE DRAWINGS

FIG. 1 is a perspective view of a vehicle having a carrier device embodying the present invention and mounted to a trailer hitch thereof;

FIG. 2 is a perspective view, in enlarged scale, of the carrier device shown in FIG. 1;

FIG. 3 is a detail perspective view, in enlarged scale, taken from the circle 3 of FIG. 2;

FIG. 4 is a longitudinal sectional view through the receiver, incorporated in the carrier device shown in FIG. 3, with a pair of locking buttons biased laterally outwardly into a locking position;

FIG. 5 is a sectional view similar to FIG. 4, but showing the locking buttons pressed inwardly for release of the receiver;

FIG. 6 is a perspective view similar to FIG. 2, but enlarged in scale, and with the receiver raised; and

FIG. 7 is a partial perspective view of a second embodiment of the carrier apparatus of the present invention.

### DETAILED DESCRIPTION OF THE PREFERRED EMBODIMENT

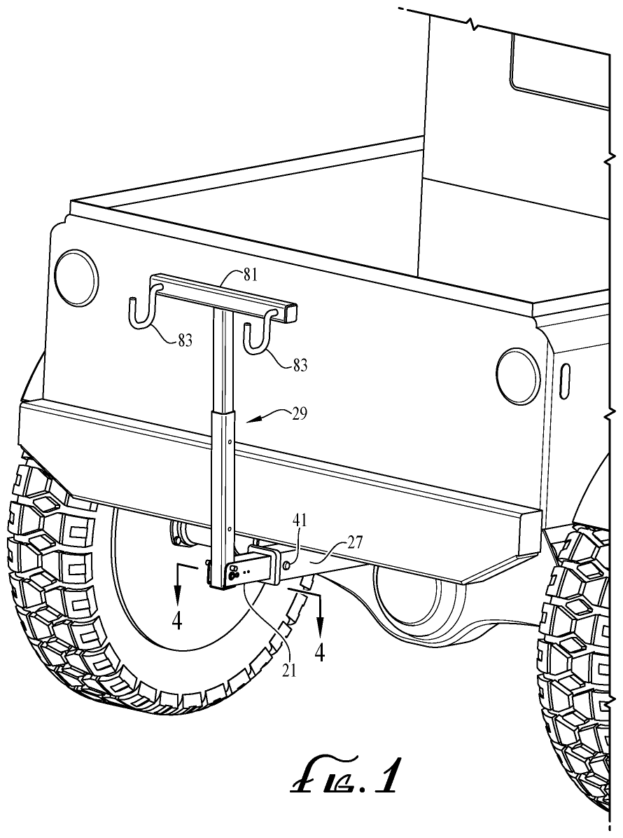

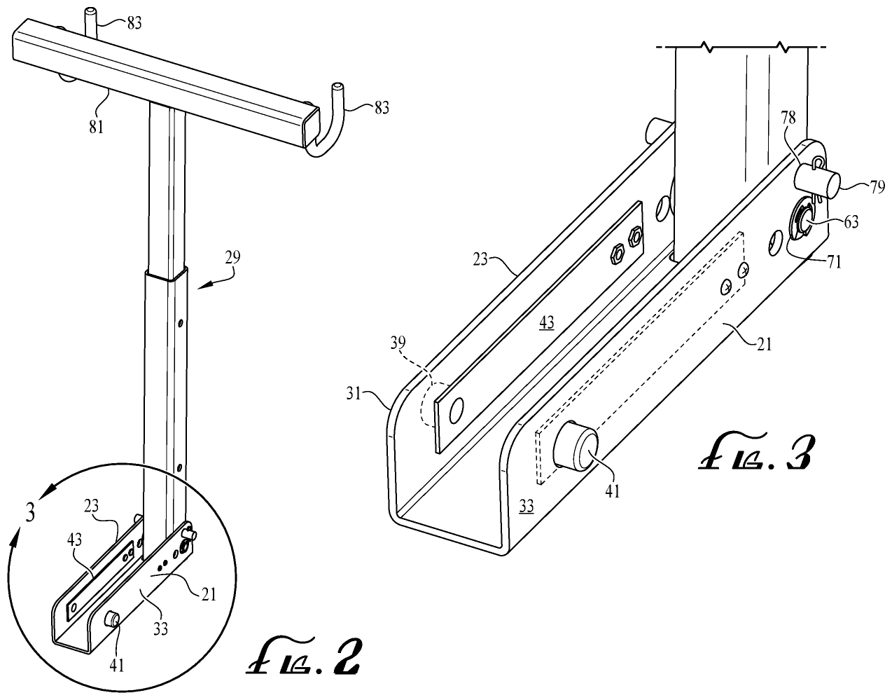

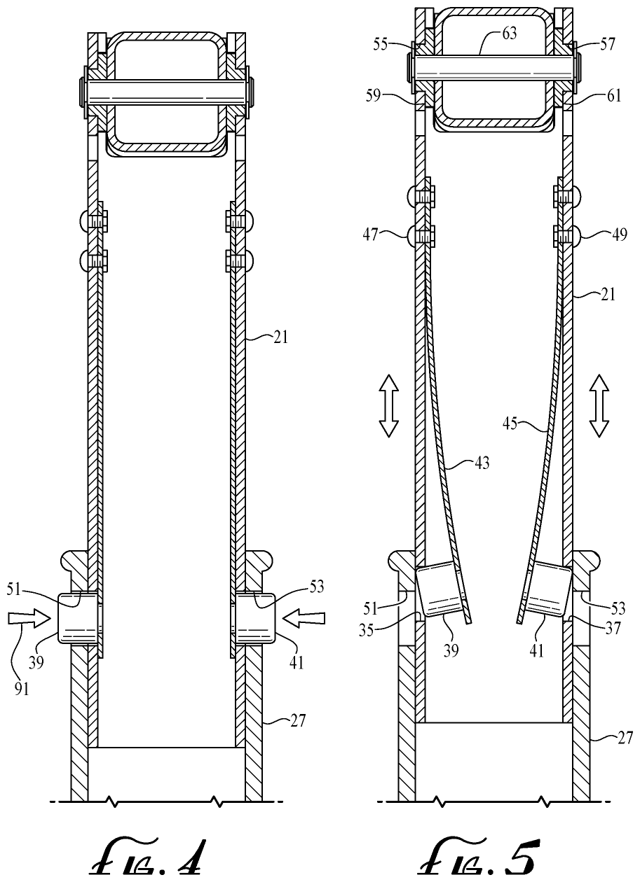

Referring to FIGS. 1, 4 and 6, the hitch-mounted carrier apparatus of the present invention includes, generally, a channel shaped receiver 21 formed with an upwardly facing channel 23 to be received at its proximal end within a tubular trailer hitch 27 and mounting at its distal extremity a stem 29 for pivoting between an erect position, shown in FIGS. 1 and 2, and a collapsed position with the stem received in the channel 23. Referring to FIGS. 3-5, the opposite walls 31 and 33 of the receiver are formed at their forward extremity with respective through bores 35 and 37 which selectively receive respective cylindrical laterally outwardly projecting elongated cylindrical buttons 39 and 41 carried on the free ends of longitudinally extending leaf spring straps 43 and 45 mounted at their respective rearward extremities by means of threaded bolts 47 and 49.

There are probably well over 100,000,000 bicycles in the United States and a greater number of vehicles, many of which have rearwardly opening tubular trailer hitches similar to the trailer hitch 27 (FIG. 1). Typically, automobiles do not have sufficient space in the interior for convenient receipt of bicycles to be carried to the bicycling destination. It is thus desirable to have a convenient and compact bicycle rack which is readily receivable in a trailer hitch 27 to be easily locked in position and having sufficient integrity to carry the weight of one or more bicycles as the vehicle maneuvers through turns and twists in the road to the destination.

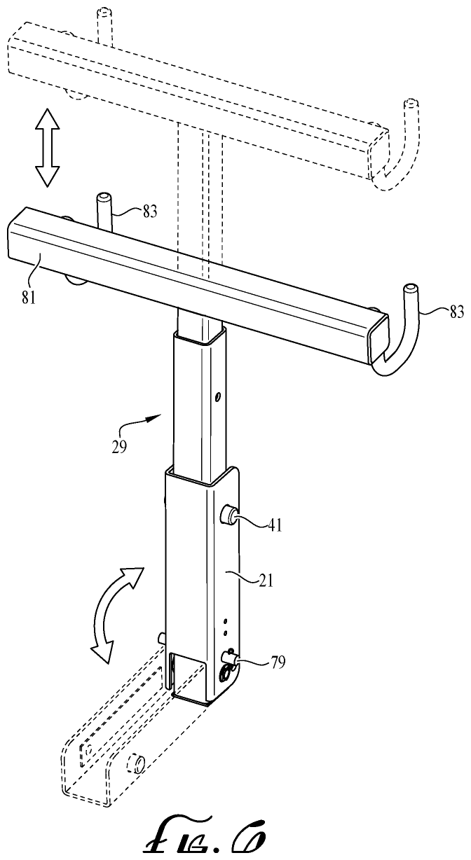

Tubular trailer hitches 27 are typically constructed of one or two standard interior cross sections for receipt of stems carrying ball hitches or the like (not shown). The hitches 27 are typically formed in their side walls with through bores 51 and 53 (FIG. 5) for receipt of pins or the like for securing a trailer tongue to the hitch. I have thus adopted the expedient of configuring my receiver 21 for snug telescopical fit within the confines of the hitch 27. I further employ the latching buttons 39 and 41 of a size and configuration to be received in the bores 51 and 53 to cooperate in latching the receiver in place.

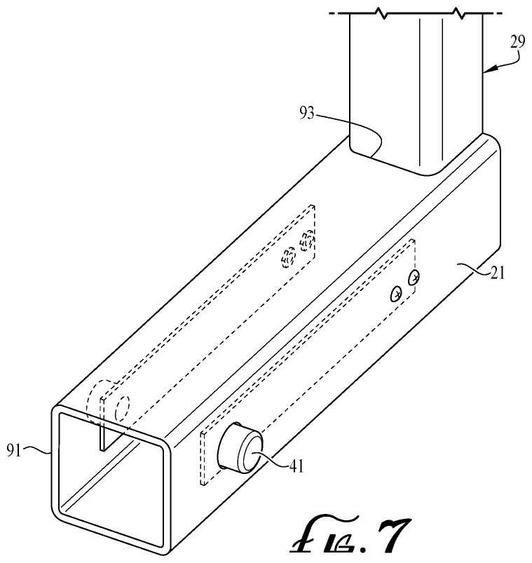

In my preferred embodiment, I form the side walls of the receiver at the rear extremity with a pair of bores 55 and 57 (FIG. 5) formed in size to receive oppositely disposed shoulder washers 59 and 61 which, in turn, receive a pivot pin 63 to pivotally connect the proximal extremity of the stem to the receiver for rotation between the vertical position shown in FIGS. 2 and 3 and a retracted horizontal position nested in the channel 23 (FIG. 6). Referring to FIG. 3, the sidewalls of the receiver are formed at the rear extremity above the level of the bores 55 with respective locking bores 78 for receipt of the opposite ends of a lock pin 79 which projects there through and through corresponding bores in the sidewalls of the stem 29 to lock the stem in its vertical position, shown in FIG. 2.

Referring to FIGS. 3-5, the leaf spring straps 43 and 45 extend along the interior surfaces of the sidewalls of the receiver with the locking buttons 39 and 41 carried from the free ends thereof. The straps 43 and 45 are constructed to carry the buttons 39 and 41 for travel through respective paths which, when the free ends of such straps are flexed outwardly juxtaposed the interior walls of the receiver as shown in FIG. 4, align the buttons with the bores 35 and 37 such that, as the receiver is inserted in the interior of the hitch 21 the buttons would be snapped laterally outwardly in the opposite directions to be received in locking relationship in the bores 51 and 53 as shown in FIG. 4.

For bicycle transportation, the stem mounts at the upper end thereof, a crossbar 81 which mounts at the opposite ends, thereof, a pair of upwardly opening hooks 83 for receiving a frame member of a bicycle or the like.

As will be appreciated by those of skill in the art, the carrier device of the present invention can be used for numerous different applications, such as for transporting bicycles, surf boards, fishing boats and the like.

In any event, it will be appreciated that the device may be folded and conveniently carried in, for instance, the trunk of a car or back of a pickup or Jeep vehicle. When it is desirable to mount the device for carrying a bicycle or the like, the stem 29 may be pivoted up to its vertical position shown in FIG. 2. To achieve this function, the pin 79 (FIG. 3) will be removed and inserted when the stem reaches its vertical extent.

The receiver may then be inserted in the hitch 27 by merely pressing the buttons 39 and 41 laterally inwardly to the general position shown in FIG. 5 so the forward extent of the receiver may be extended in the hitch and slid forwardly as the operator slides his or her fingers free of the outside end surfaces of buttons 39 and 41 to allow such end surfaces to slide along the interior of the hitch in cam fashion until the buttons register with the respective bores 51 and 53 to be snapped laterally outwardly by the spring straps 43 and 45 to the position shown in FIG. 4. The receiver is thus securely locked in position within the hitch, to thus carry a load placed on the hooks 83.

In the event the carrier device is to be removed from the hitch, the operator need merely press the buttons 39 and 41 laterally inwardly as depicted by the arrows 91 shown in FIG. 4 to thus clear the bores 51 and 53 of the hitch thereby freeing the receiver to be drawn rearwardly of the hitch as the laterally outward surfaces of the buttons drag along the interior surface of the sidewalls of the hitch. The stem 29 may then be collapsed by removing the pin 79 and rotating the stem counterclockwise, as viewed in FIGS. 2 and 3 to lower it into the channel of the receiver 21, as shown in FIG. 6, for convenient transport thereof.

The embodiment shown in FIG. 7 is similar to that shown in FIG. 1 except that the receiver 21 is in the form of a square tube 91 having the leaf springs 43 and 44 mounted on the inner surface of the side walls and is formed at its upper wall, at the rearward extremity with a rectangular opening 93 for receipt of a stem 29 which is constructed to be selectively inserted in the opening 93 and removed therefrom for storage.

As will be apparent to those skilled in the art, some embodiments of the present invention include only a single leaf spring, associated lock button 39, 41 and receiving bores and in other embodiments, the leaf springs may be cantileverly mounted from their respective forward ends.

From the foregoing, it will be appreciated that the carrier device of the present invention is sturdy, economical to manufacture and provides for convenient collapse thereof for storage and quick and straightforward deployment for mounting to a trailer hitch.

1. (canceled)

2. The carrier rack of claim 10, for carrying bicycles and including:
a crossmember supported by the stem and including upwardly opening hooks.

3. The carrier rack of claim 10 wherein:
the opposite side walls are formed with respective rearward extremities including latching bores spaced from the pivot axis of the stem; and
a latching pin removably received in the respective latching bores.

4. The carrier rack of claim 10 wherein:
the stem includes multiple sections configured for selective extension relative to one another for adjusting the length of the stem.

5. A carrier rack apparatus; comprising:
a rearwardly opening horizontal, rectangular tubular hitch formed with a rearwardly opening rectangular tunnel having opposite hitch side walls, the hitch mounted at the rear of the vehicle:
an elongated receiver having a rectangular transverse cross section and including receiver formed with side wall forward and rearward extremities, the forward extremity constructed for receipt in the tunnel hitch;
a stem for mounting from the receiver and formed with a carrier;
a pivot device mounting the stem from the receiver;
a pair of leaf springs mounted to the interior surfaces of the respective side walls of the receiver and formed with forward extremities mounting laterally outwardly projecting locking buttons;
the side walls on the receiver being formed with through bores to be aligned for passage of the respective locking buttons.

6. The carrier rack of claim 5 wherein:
the receiver includes a top wall having an opening formed for close fit receipt of the transverse cross section of the stem.

7. The carrier rack of claim 5 wherein:
the receiver is channel-shaped.

8. The carrier rack of claim 7 wherein:
the receiver is formed to, when the stem is in a collapsed position, be received about a portion of the stem.

9. (canceled)

10. A carrier rack to be mounted to a hitch formed with a rectangular rearwardly opening hitch tunnel including a pair of oppositely disposed vertical planer hitch side walls having interior surfaces, formed with respective hitch bores, and comprising:
an elongated rectangular receiver to be inserted in the hitch tunnel to a hitch position and including a channel configured with front and rear extremities, the front extremity being formed for receipt in the tunnel to leave the rear extremity projecting cantileverly thereform;
an elongated stem pivotally connected on one end to the rear extremity to pivot about a pivot axis and configured to be partially nested in the channel of the receiver as the receiver is pivoted to a retracted position, coextensive with the stem;
the receiver including opposite planer side walls having through receiver bores configured to be, when the receiver is in the hitch position, align with the hitch bores;
leaf springs mounted to the interior surfaces of the respective opposite wails, and configured with free ends biased laterally outwardly to locking positions; and
locking buttons on the respective free ends configured to be, when the hitch and receiver bores are aligned and the leaf springs in the locking positions, project outwardly through the respective receiver and hitch bores.
